(19) United States
(12) Patent Application Publication
(10) Pub. No.: US 2003/0208508 A1
(43) Pub. Date: Nov. 6, 2003

(54) Expert five element energy analysis system

(76) Inventor: E-Chain Cheng, Taichung (TW)

Correspondence Address: VENABLE, BAETJER, HOWARD AND CIVILETTI, LLP, P.O. BOX 34385, WASHINGTON, DC, 20043-9998, US

(21) Appl. No.: 10/455,348

(22) Filed: Jun. 6, 2003

Related U.S. Application Data
(63) Continuation-in-part of application No. 09/668,730, filed on Sep. 25, 2000, now abandoned.

(51) Int. Cl. G06F 7/00

(52) U.S. Cl. 707/104.1

(57) ABSTRACT

An expert Five Elements energy analysis system has a user interface for inputting data and printing calculated results and a Five Elements energy analytic module. The Five Element energy analytic module includes a Five Elements transformation module, a Natural Elements and Energy analytic numeric database and means for transforming the Five Elements energy numbers into a Five Elements energy code. The Five Elements transformation module transforms the input data into a Five Elements arrangement function. The Natural Elements and Energy analytic numeric database transforms the Five Elements arrangement function into Five Elements energy numbers. By such an arrangement, the analysis system can transform each input data element into a Five Elements energy code in addition to connecting to the data in the other database through the Internet. Consequently, the comparison and the calculation between the data elements of different databases can be simplified.

The present invention relates to a CIP (continuation-in-part) application, and more particularly to a CIP application to the U.S. Ser. No. 09/668,730 patent application.

### BACKGROUND OF THE INVENTION

1. Field of the Invention

2. Description of Related Art

A conventional database is composed of a huge amount of data with each data element coded in a desired way. A unique program is needed to calculate and correlate the data in different databases. However, a unique program dealing with two specific databases cannot be used to deal with other different databases. The data in one database cannot be used to compute directly and correlate with data in another different database, such that the use of the conventional program is limited. Furthermore, the conventional database cannot be used widely in the Internet environment and electronic commerce.

To overcome the shortcomings, the present invention tends to provide an expert Five Elements energy analysis system to mitigate or obviate the aforementioned problems.

### SUMMARY OF THE INVENTION

The main objective of the invention is to provide an expert Five Elements energy analysis system having a user interface to input data and print calculation results and a Five Elements energy analytic module that can generate a set of classical Chinese Five Elements energy numbers based on user input data and convert the set to an energy code. The Five Element energy analytic module includes a Five Elements transformation module, a Natural Elements and Energy analytic numeric database and means for transforming the Five Elements energy numbers into a Five Elements energy code. The Five Elements transformation module transforms the input data into a Five Elements arrangement function. The Natural Elements and Energy analytic numeric database transforms the Five Elements arrangement function into Five Elements energy numbers. The means for transforming the Five Elements energy numbers into a Five Elements energy code simplifies the correlation and the calculation between the data elements of different databases.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of the data input through the user interface of an expert Five Elements energy analysis system in accordance with the present invention;

FIG. 2 is a flow chart of the transformation of the input data into a Five Elements energy code by a Five Elements energy analytic module in accordance with the present invention;

FIG. 3 is a flow chart of the correlation of the input data and the data element of another connecting database by the expert Five Elements energy analysis system in accordance with the present invention;

FIG. 4 is a flow chart of the Five Elements energy analytic module connected with the other database in FIG. 3;

FIG. 5 is an operational diagram of the expert Five Elements energy analysis system in FIG. 3 in use on the Internet;

FIG. 6 is a flow chart of the analysis system in FIG. 5;

FIG. 7 is a flow chart of the Five Elements energy analytic module connected with the database at service supplier in FIG. 5; and

FIG. 8 is a flow chart of modifying the data elements of the Natural Elements and Energy analytic numeric database in FIG. 7.

### DETAILED DESCRIPTION OF PREFERRED EMBODIMENT

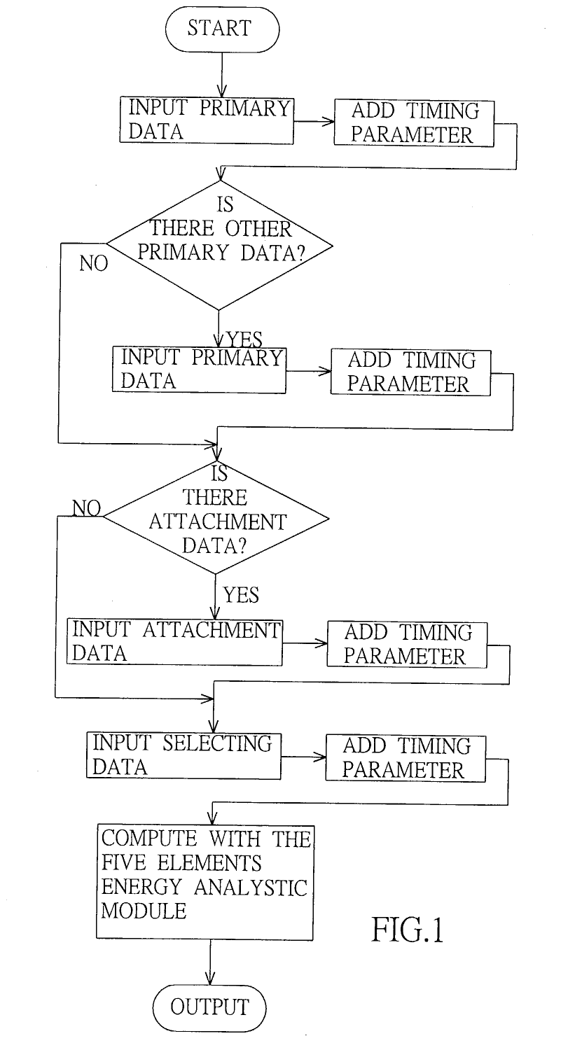

With reference to FIG. 1, an expert Five Elements energy analysis system in accordance with the present invention can be used in personal computers or connected to other computers through the Internet. The operational system comprises a user interface, a Five Elements energy analytic module and a Natural Elements and Energy analytic numeric database, wherein the Five Elements has Metal element, Wood element, Water element, Fire element and Earth element from Chinese traditional culture.

The user interface allows a user to input the data needed by the analysis system. The steps for the user to input the data comprise:

1. inputting the primary data;

When the subject of the analysis is a person, the primary data could include the name, the sex or the year, month and date of the birth of the person. If the subject is a corporation, the primary data could include the name of the entity, the main products, names of the clients or customers and so on.

2. choosing whether to input other primary data:

Whether the user wants to input other primary data or not, results in “yes” or “no” being selected respectively.

3. inputting the other primary data:

Any other primary data could be the time including the minute and second of birth/establishment and the birthplace for a person or the manufacturer, location and time for a product.

4. choosing whether to input attachment data:

Whether the user wants to input attachment data or not results in “yes” or “no” being selected respectively.

5. inputting the attachment data:

The attachment data could be information about the user's family.

6. inputting the selecting data:

The selecting data mainly includes a time item and an object item. The time item could comprise the start time, a desired time or period or a given year, month or day. The object item could comprise “love and health”, “investment and finance”, “eminence and chance”, “business and job” and “friends and family”.

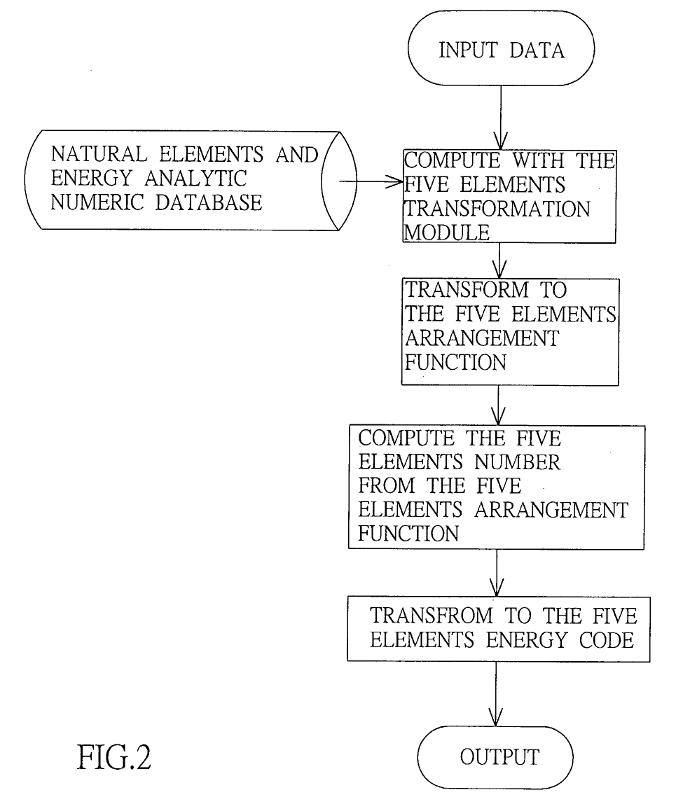

With reference to FIGS. 1 and 2, the Five Elements energy analytic module is used to transform the input data to a corresponding Five Elements energy code. The Five Elements analytic module mainly includes a Five Elements transformation module for transforming the primary data, the other primary data and the attachment data into a Five Elements arrangement function in accordance with the classical Chinese Five Elements Theory. Wherein, the Five Elements arrangement function is a function with varieties of the elements of the Ten Heavenly Stems and the Twelve Earthly Branches. The Ten Heavenly Stems includes “ [symbol] ” (the first element referred to as TP), “ [symbol] ” second element referred to as TN), “ [symbol] ” (the third element referred to as FP), “ [symbol] ” (the fourth element referred to as FN), “ [symbol] ” (the fifth element referred to as EP), “ [symbol] ” (the sixth element referred to as EN), “ [symbol] ” (the seventh element referred to as MP), “ [symbol] ” (the eighth element referred to as MN), “ [symbol] ” (the ninth element referred to as WP), “ [symbol] ” (the tenth element referred to as WN). The TP and TN are referred to the Wood element of the Five Elements, the FP and FN are referred to the Fire element of the Five Elements, the EP and EN are referred to the Earth element of the Five Elements, the MP and MN are referred to the Metal element of the Five Elements and the WP and WN are referred to the Water element of the Five Elements.

Each element of the Ten Heavenly Stems can be shown as follow function:

36(1+f(x)),

wherein f(x) has a range from −1 to 1 in accordance with neuro-fuzzy method.

The Twelve Earthly Branches includes rat (the first element referred to as RA), ox (the second element referred to as OX), tiger (the third element referred to as TI), hare (the fourth element referred to as HA), dragon (the fifth element referred to as DR), snake (the sixth element referred to as SN, horse (the seventh element referred to as HO), sheep (the eighth element referred to as SH), monkey (the ninth element referred to as MO), rooster (the tenth element referred to as RO), dog (the eleventh element referred to as DO) and pig (the twelfth element referred to as PI).

The elements of the Twelve Earthly Branches can be shown as follow functions:

RA=f(WN,TP);

OX=f(EN,WN,WP,MP,MN);

TI=f(TP,FP);

HA=f(TN,FP);

DR=f(EP,TN,TP,MP,MN);

SN=f(FP,EP,EN);

HO=f(EP,TN,TP,MP,MN);

SH=f(EN,FN,FP,TN);

MO=f(MP,WP);

RO=f(MN,WP);

DO=f(EP,MN,MP,FN);

and

PI=f(WP,TP).

Wherein, each function is a simple equation of the corresponding varieties, for example,

RA=0.9(WN)+0.1(TP),

and

DR=0.5(EP)+0.2(TN)+0.1(TP)+0.1(MP)+0.1(MN).

According to the classical Chinese Five Elements Theory, everything in the world can be stated in the Ten Heavenly Stems and the Twelve Earthly Branches form. For example, the date, Mar. 28, 1985, can be stated TN OX (referred to year), EN HA (referred to month), FP TI (referred to date) in the Ten Heavenly Stems and the Twelve Earthly Branches form. Consequently, each date can be transformed to a specific Five Elements arrangement function.

In addition, the Five Elements transformation module can transform the name of a person or a corporation into the Five Elements arrangement function based on the number of strokes in the name in Chinese characters. The Five Elements transformation module can also transform the year, month and date of birth of one person into the Ten Heavenly Stems and the Twelve Earthly Branches furthermore into the Five Elements arrangement function. A Five Elements arrangement function referring to a person can be transformed in accordance with the person's name, the birth date, the birth place, sex and so on.

The Natural Elements and Energy analytic numeric database has a number of numeric elements each corresponding to one of the elements of the Ten Heavenly Stems, the Twelve Earthly Branches and the Five Elements. Each numeric element in the Natural Elements and Energy analytic numeric database has a predetermined value and a variable. The initial value of the variable of each numeric element can be set to zero. Consequently, the Five Elements arrangement function can be calculated as a set of five numbers from the numeric elements in the database, wherein each number corresponds to one of the Five Elements. For example, the number corresponding to the Wood element can be a sum of the corresponding TP and TN. Furthermore, a code corresponds to the weighted ratio of each Five Elements number to the total of the five numbers.

For example, if the Five Elements arrangement function computes the five numbers, Wood 63, Fire 83, Metal 72, Earth 64 and Water 48 based on the time of birth of a person, the code for Wood is 19 because the number for Wood 63 over the total 330 is 0.19. In this manner, the code for Fire is 25, the code for Metal is 22, the code for Earth is 19 and the code for Water is 15. Consequently, a specific code is generated with each code of the corresponding element of the Five Elements.

In another embodiment, a code referring to an element of the Five Elements can be achieved by means of averaging the numbers corresponding to the sub-functions referring to the element. For example, a code corresponding to the Wood element is achieved by means of averaging the numbers corresponding to the corresponding sub-functions TP and TN.

In addition, the Five Elements energy analytic module can be used to transform the selecting data into a variable code appended to the specific code.

Consequently, the Five Elements energy code can be achieved by the combination of the specific code transformed from the primary data and the variable code transformed from the selecting data. For example, a “Mr. Chen” born on Jan. 23, 1970 at 12:00 A.M. has a Five Elements energy code 14T21F15E27M23W transformed by the Five Elements energy analytic module in accordance with the present invention. An object has a Five Elements energy code 42T23F17E14M04W transformed by the Five Elements energy analytic module in accordance with the present invention in accordance with the shape, the color or the manufacturer. A code developed from the other primary data or the attachment data can be selected to add to the Five Elements energy code. The calculated results of the analysis system can be printed over the user interface in the form of a wave diagram, an energy table or a literal description according to the relationship of the Five Elements theory.

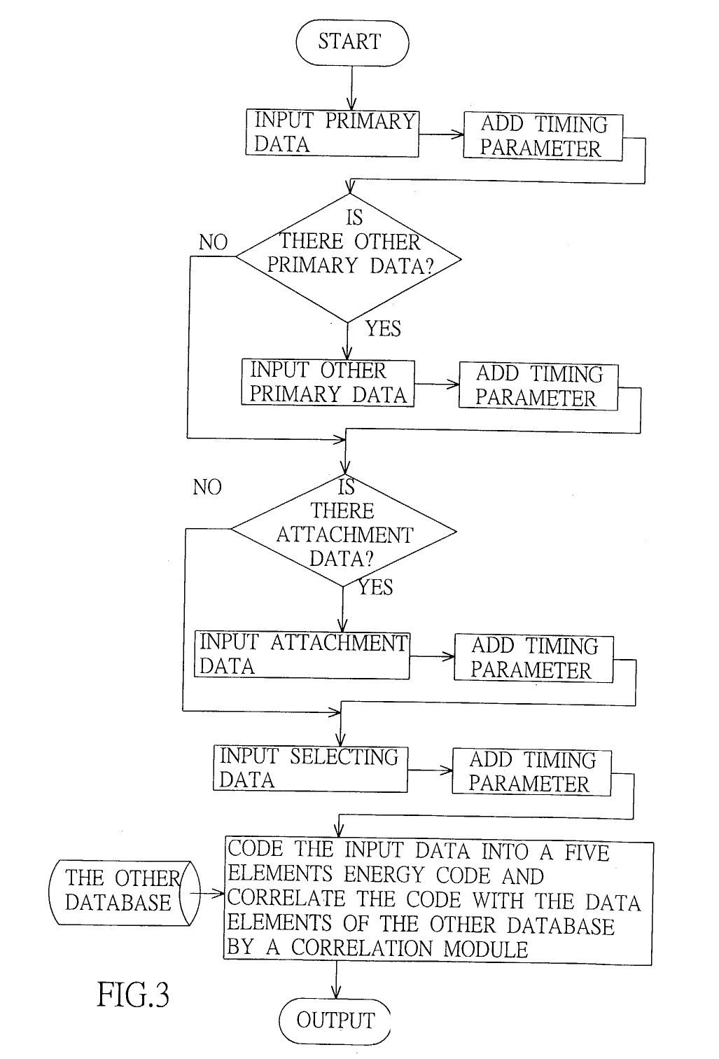

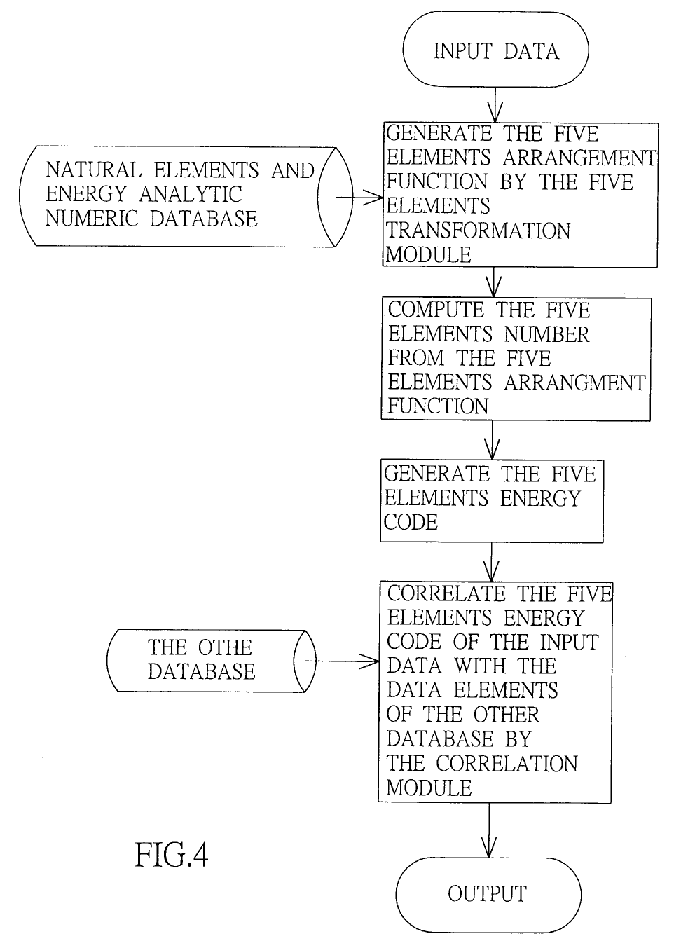

With reference to FIGS. 3 and 4, the Five Elements energy analysis system can connect to another database through the Internet, wherein each data element in the database is also coded into a Five Elements energy code. A correlation module is provided to correlate and compute the relationship between the Five Elements energy codes of the input data and the connected data by means of the relationships of the Five Elements. Consequently, the correlation and the calculation between the data elements of different databases are simplified.

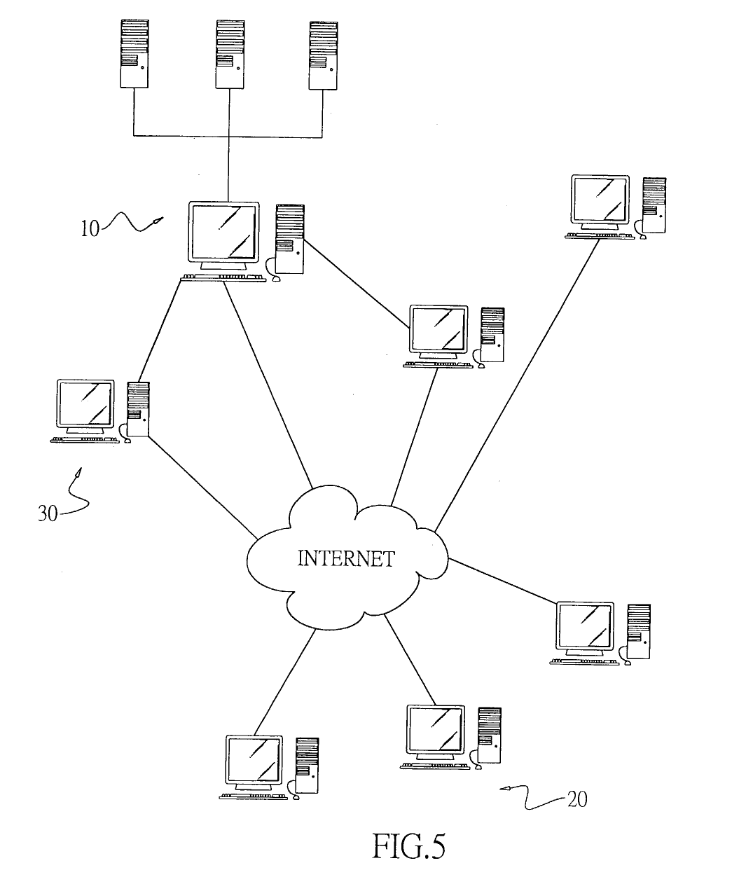

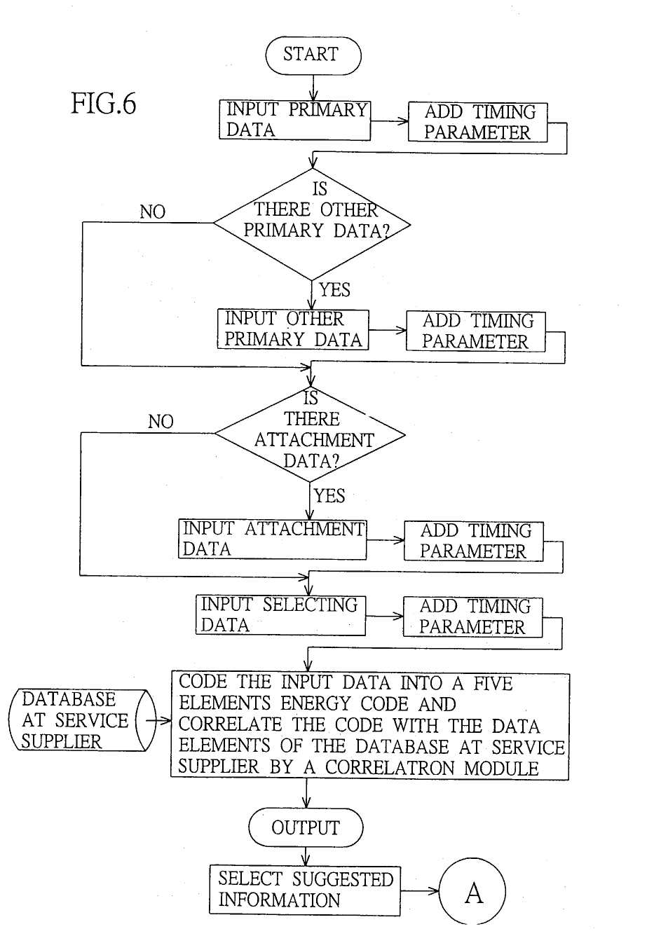

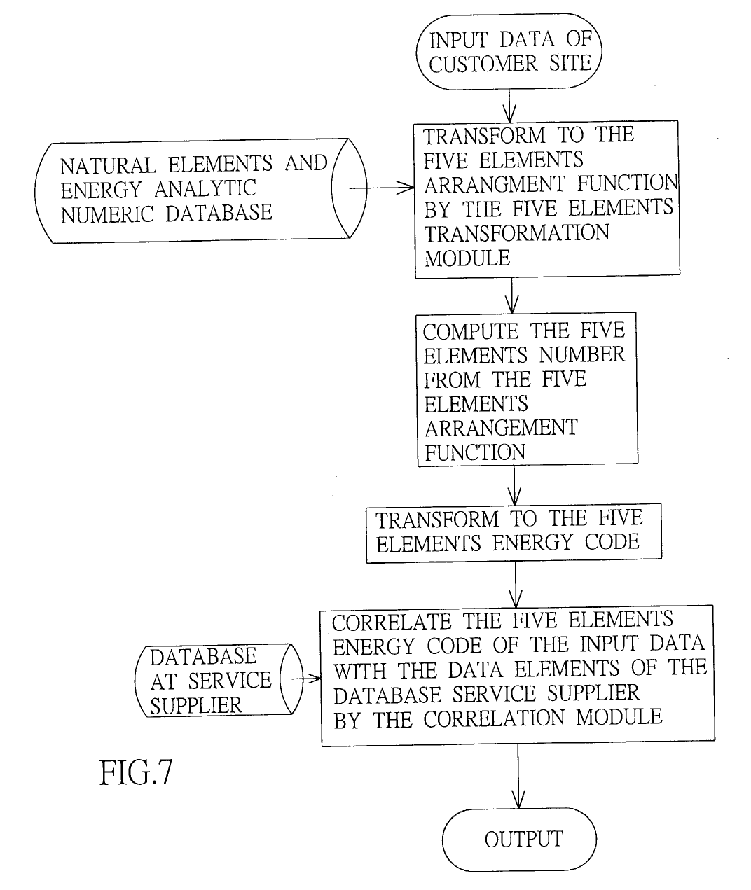

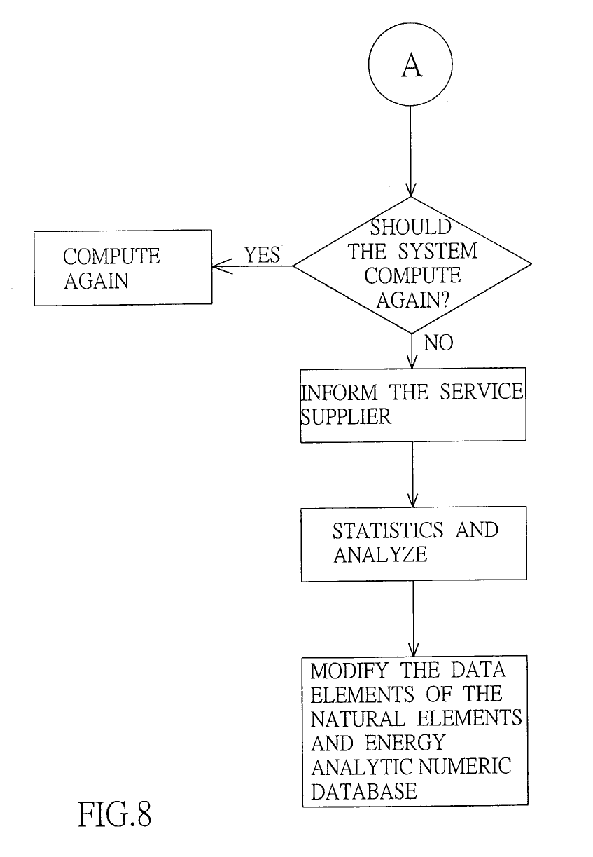

In practice, with reference to FIGS. 5-8, a server (10) with the expert Five Elements energy analysis system connects multiple customer sites (20) and service suppliers (30) through the Internet. Thus, a user can input data through the computer at the customer site (20), and the data can be transmitted to the server (10) in addition to being transformed into the corresponding Five Elements energy code. In addition, the data stored at the service supplier (30) can also be transmitted to the server (10) and transformed into the corresponding Five Elements energy code. Consequently, the server (10) can deal with the Five Elements energy codes of user's data and a service supplier's data through the Five Elements energy analysis system, and provided information can be transmitted to the customer site (20). The user can select the items of information that he or she needs.

Furthermore, the user can choose to compute the Five Elements codes again if the items of information do not meet his or her needs. If the user decides not to compute the Five Elements codes again, this means that the items of information meet the user's need. The server (10) will inform the corresponding service supplier (30) of the user's choice(s), and the selected items will be recorded and analyzed. The statistics and analysis result will be used to modify the variable in the numerical element in the Natural Elements and Energy analytic numeric database, such that the final choice of the user can be considered in the next operation of the analysis system. The calculated results of the analysis system will be exact and close to the user's needs.

With reference to FIGS. 1, 4 and 6, when the user inputs each data element through the user interface, a timing parameter will be generated based on the time each data element is input. The timing parameter will be appended to the Five Elements energy code, such that a timing control term will be achieved in each Five Elements energy code.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An expert Five Elements energy analysis system comprising:
a user interface for inputting data and printing calculated results; and
a Five Elements energy analytic module including a Five Elements transformation module to transform the input data into a Five Elements arrangement function with varieties of elements of the Ten Heavenly Stems, the Twelve Earthly Branches in accordance with the classical Chinese Five Elements Theory;
a Natural Elements and Energy analytic numeric database with multiple numeric elements to transform the Five Elements arrangement function into Five Elements energy numbers; and
means for transforming the Five Elements energy numbers into a Five Elements energy code.

2. The analysis system as claimed in claim 1, wherein the steps for inputting data comprise inputting primary data and inputting selecting data.

3. The analysis system as claimed in claim 2, wherein the primary data is transformed into a specific code by the Five Elements analytic module.

4. The analysis system as claimed in claim 2, wherein the selecting data is transformed into a variable code by the Five Elements analytic module.

5. The analysis system as claimed in claim 4, wherein the Five Elements energy code is composed of a specific code and a variable code.

6. The analysis system as claimed in claim 5, wherein the selecting data includes a time item and an object item.

7. The analysis system as claimed in claim 6, wherein the time item comprises a start time, a desired time or period and a given year, month and day.

8. The analysis system as claimed in claim 5, wherein the object item comprises “love and health”, “investment and finance”, “eminence and chance”, “business and job” and “friends and family”.

9. The analysis system as claimed in claim 2, wherein the steps for inputting data further comprise inputting the other primary data.

10. The analysis system as claimed in claim 2, wherein the steps for inputting data further comprise inputting attachment data.

11. The analysis system as claimed in claim 2 further comprising a timing parameter generated when each data element is input and is added to the Five Elements energy code.

12. The analysis system as claimed in claim 1, wherein each numeric element in the Natural Elements and Energy analytic numeric database has a predetermined value and a variable.

13. The analysis system as claimed in claim 12, wherein the initial value of the variable of each numeric element is zero.

14. The analysis system as claimed in claim 1, wherein means for transforming the Five Elements energy numbers into a Five Elements energy code is a weighted ratio of each Five Elements number of the total of the numbers.

15. The analysis system as claimed in claim 1, wherein each element of the Ten Heavenly Stems is shown as follow function:
36(1+f(x)),
wherein f(x) has a range from −1 to 1.

16. The analysis system as claimed in claim 15, wherein each element of the Twelve Earthly Branches is shown as a function with varieties including multiple elements of the Ten Heavenly Stems, and each function is a simple equation of the corresponding varieties.
